(19) United States
(12) Patent Application Publication
(10) Pub. No.: US 2015/0290980 A1
(43) Pub. Date: Oct. 15, 2015

(54) TIRE TREAD WITH IMPROVED TREAD ELEMENT EDGE

(71) Applicant: Zuqing QU, (US)

(72) Inventor: Zuqing Qu, Greer, SC (US)

(73) Assignees: Michelin Recherce Et Technique S.A., Granges-Paccot (CH); Compagnie Generale Des Etablissements Michelin, Clermont-Ferrand (FR)

(21) Appl. No.: 14/439,171

(22) PCT Filed: Oct. 31, 2012
(86) PCT No.: PCT/US12/62879

§ 371 Date: Apr. 28, 2015

(51) Int. Cl. B60C 11/13; B60C 5/00

(52) U.S. Cl. CPC B60C 11/13; B60C 5/00

(57) ABSTRACT

Particular embodiments of the present invention comprise a tire tread having a length and a width. The tread further includes a thickness bounded by a top side for engaging a surface during tire operation and a bottom side. Moreover, the tread includes a top side void arranged along the top side of the tread and defining a wall extending depthwise within the tread thickness from the top side. Finally, the tread includes a projection extending outwardly from the wall and to a terminal end of the projection, the projection having a top side and a bottom side defining a thickness of the projection, the projection also having a length extending longitudinally along a length of the wall, the length of the wall extending perpendicular to a depthwise direction of the tread thickness. Further embodiments comprise a tire including a tire carcass and a tread as described in the preceding paragraph.

### BACKGROUND OF THE INVENTION

This invention relates generally to improved tire treads, and more specifically, tire treads having tread elements with improved edges.

### DESCRIPTION OF THE RELATED ART

It is known for tires to have treads for engaging a ground surface and thereby provide grip facilitating vehicle acceleration, braking, and cornering. The tread includes a ground-engaging side including ground engaging surfaces upon which the tire operates along the ground surface. The ground-engaging side is also referred to as an outer, annular tire operating side. To achieve particular performance capabilities, the ground-engaging side may include features, such as, for example, voids comprising grooves and sipes. These features form edges along the ground-engaging side of the tread. Edges may also be formed along the perimeter of ground-engaging tread elements, where the perimeter is formed by one or more tread features. In other words, tread features may parse the ground-engaging side into various ground-engaging tread elements. These tread elements may comprise, for example, ribs and blocks of various shapes and sizes. The ground-engaging surface of these tread elements includes a perimeter comprised of one or more edges.

It is also known that during the course of a tire's life, the tread thickness becomes thinner as the tread wears. In certain instances, it is known for the tread to experience irregular wear. It has been found, however, that in such instances, edges of the ground-engaging tread elements experience significant stress concentrations. In an effort to reduce irregular tread wear, there is a need to reduce the occurrence of significant stress concentrations arising at the edges of ground-engaging tread elements.

### SUMMARY OF THE INVENTION

The present invention includes methods and apparatus for reducing and/or relocating stress concentrations along any edges arranged along an outer, ground-engaging surface of a tread. Particular embodiments comprise a tire tread including a length extending longitudinally and a width extending laterally relative the length. The tread further includes a thickness bounded by a top side for engaging a surface during tire operation and a bottom side for attachment to a tire carcass. Moreover, the tread further includes a top side void arranged along the top side of the tread and defining a wall extending depthwise within the tread thickness from the top side. Finally, the tread includes a projection extending outwardly from the wall and to a terminal end of the projection, the projection having a top side and a bottom side defining a thickness of the projection, the projection also having a length extending longitudinally along a length of the wall, the length of the wall extending perpendicular to a depthwise direction of the tread thickness.

Further embodiments of the present invention comprise a tire including a tire carcass and a tread as described in the preceding paragraph.

The foregoing and other objects, features and advantages of the invention will be apparent from the following more detailed descriptions of particular embodiments of the invention, as illustrated in the accompanying drawings wherein like reference numbers represent like parts of the invention.

### BRIEF DESCRIPTION OF THE DRAWINGS

FIG. 1 is a sectioned perspective view of a tire, the tire including a tread having a ground-engaging side extending annularly around the tire and including a tread having a plurality of tread elements having improved edges in accordance with an embodiment of the invention.

FIG. 2 is a partial sectional view of a tread showing the widthwise cross-section of an exemplary tread element showing a ground-engaging tread element arranged between longitudinal grooves.

FIG. 3 is a top view of a tread element of the exemplary tire shown in FIG. 1.

FIG. 4 is a partial sectional view of an alternative embodiment of the tread element of FIG. 2 for use in the tread of FIG. 1.

FIG. 5 is a partial top view of a tread element comprising a rib extending in a lengthwise along a non-linear path in a longitudinal direction of the tread in accordance with a particular embodiment of the invention.

FIG. 6 is a partial sectional view of a prior art tread element.

FIG. 7 is a graph comparing the stress concentrations calculated along inventive tread elements against the stress concentrations calculated along a prior art tread element, where the stress concentrations were calculated using finite element analysis.

### DETAILED DESCRIPTION OF PARTICULAR EMBODIMENTS

As suggested above, there is a need to provide improved treads for reducing the occurrence of irregular wear. In doing so, there is a need to reduce the magnitude of stress concentrations along the edges arranged along the ground-engaging side of the tread. There is also a need to move the stress concentrations further away from the center of the tread element.

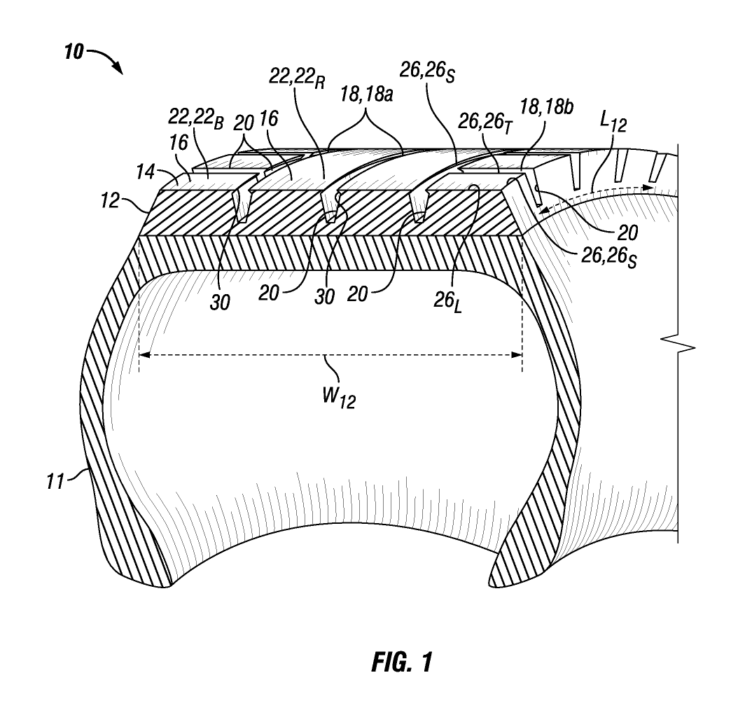

With reference to FIG. 1, an exemplary pneumatic tire 10 is shown. The tire 10 includes a tread 12 attached to a tire carcass 11, which includes a pair of opposing sidewalls extending radially to a central portion to which the tread is attached. The tread 12 extends annularly around the tire in a longitudinal direction L₁₂ of the tread and across at least a portion of the tread width W₁₂ to define a ground-engaging side 14 of the tread. The ground-engaging side 14 of the tread includes one or more ground-engaging surfaces 16 upon which the tire operates along the ground surface. The ground-engaging side is also referred to as a top or outer side of the tread, while the ground-engaging surfaces are also referred to as tire operating surfaces. It is understood that the ground surface may comprise any surface upon which a tire operates whether natural or artificial. To achieve a desired tire performance, the ground-engaging side 14 includes one or more voids 18 (also referred to herein as top side voids)extend depthwise into a thickness T₁₂ of the tread from the ground-engaging side. The thickness T₁₂ extends from the ground-engaging side 14 to a bottom side 17 of the tread configured for attachment to the tire carcass 11. Each void 18 may comprise any desired void. For example, void 18 may form a groove or sipe generally representing a narrow groove, each of which may extend in any direction of the tread. It is noted that in the exemplary tread shown in FIG. 1, top side voids 18 comprise longitudinal grooves 18a generally extending in a lengthwise direction of the tread and lateral grooves 18b generally extending in a widthwise direction of the tread.

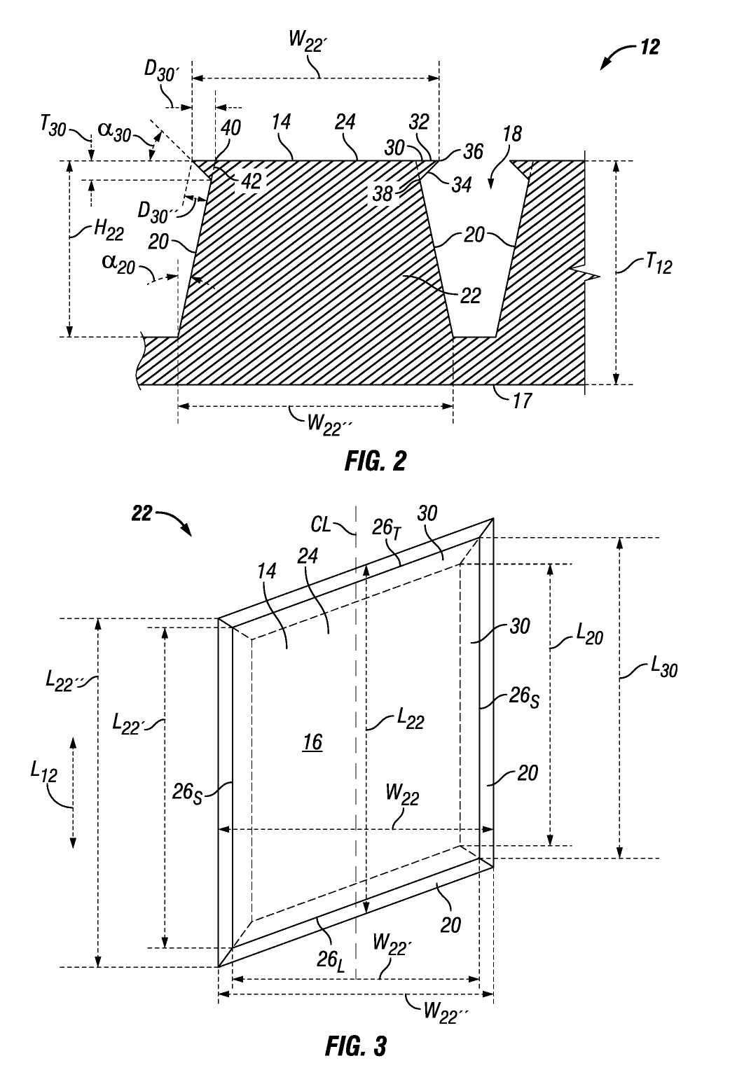

With reference to FIG. 2, each top side void 18 generally defines a wall 20 adjacent thereto extending depthwise within the thickness of the tread. Wall 20 may comprise one or more surfaces extending depthwise within the tread thickness. Furthermore, more generally, wall 20 extends both depthwise through a thickness of the tread and lengthwise in any longitudinal and/or lateral direction of the tread (that is, in other words, a wall may extend lengthwise in any direction perpendicular to, or transverse to, the depthwise direction of the tread thickness).

In certain instances, one or more top side voids 18 may be configured to form a tread element 22 arranged along the ground-engaging side 14 of the tread, where the tread element includes one or more walls 20 also known as side walls. A tread element 22 comprises a portion of the tread extending depthwise within the tread thickness, where a free end or terminal end 24 of the tread element terminates along the ground-engaging side 14 of the tread and includes a ground-engaging surface 16. Tread elements 22 may comprise, for example, ribs 22_{R} or blocks 22_{B} of various shapes and sizes. Generally, ribs extend continuously around the tread circumference, while blocks extend partially around the tread circumference. With reference to FIG. 2, a widthwise cross-section of tread element 22 is shown to have a width extending perpendicular to the lengthwise direction of the tread, where the lengthwise direction of the tread may extend linearly or non-linearly, such as extending along a curvilinear or laterally alternating path. For example, a rib is shown extending lengthwise L₂₂ in a laterally alternating path comprising a zig-zagging path extending in a longitudinal direction L₁₂ of the tread. With reference again to FIG. 2, the tread element 22 has a width taken along the ground-engaging side 14 is identified as W_{22′} while the width taken at the base of the tread element at the bottom of the adjacent void is identified as W_{22″}. It can be said that each wall 20 extends the full or partial height H₂₂ of the tread element 22 or depth of the void 18, where H₂₂ also represents the depth of the void in FIG. 2.

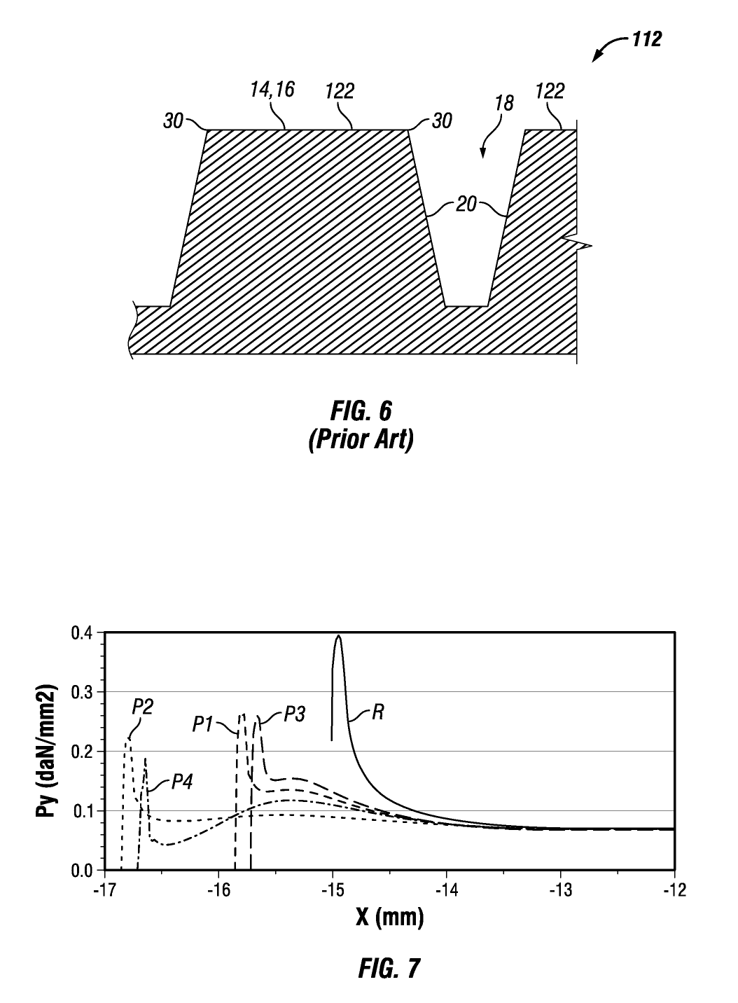

With reference to a prior art tread 112 and tread element 122 of in FIG. 6, a wall 20 formed by a top side void 18 extends depthwise through a depth of the tread to intersect the ground-engaging side 14 of the tread, where the intersection forms an edge 26 along the ground-engaging side. It is at these edges where significant stress concentrations arise, which may facilitate the occurrence of irregular wear along the tire tread during tire operations.

With reference again to FIGS. 1-2, an inventive tread includes a projection 30 extending outwardly from a wall 20 formed in association with a top side void 18. In the particular embodiment shown, the projection 30 is also arranged such that a top side 32 of the projection forms an extension of the ground-engaging side 14 and of the ground-engaging surface 16, where edge 26 is now located at a terminal end 36 of the projection which in effect moves the edge more outwardly from the wall 20 in comparison to prior art treads. Therefore, in such embodiments, it can be said that the projection 30 is arranged along an edge 26 of the top side void 18. In other embodiments, the projection may be arranged such that the top end of the projection is arranged below the ground-engaging side to form a recessed projection in the original or new tread for the purpose of reducing concentration stresses along the ground-engaging surface in a worn tire. This recessed projection becomes operable when the top end of the projection and the worn ground-engaging surface are co-planar after a sufficient thickness of the tread has worn.

It is also noted, with reference to FIG. 3, that the projection 30 extends lengthwise along each wall 20. While the projection 30 is shown to have a length L₃₀ extending a full length L₂₀ of each wall nearest the ground-engaging side 14 (such as where the wall and the projection intersect), it is understood that the projection may extend lengthwise any distance less than a length of the wall. When extending a distance less than the length of the wall, one projection may be arranged along the wall or a plurality of spaced apart projections may be arranged along the wall, such as to form an array or a discontinuous series of projections along a length of the wall. It is also noted that the projection 30 may extend the full length L_{22′} or width W_{22′} of the tread element top side or edge, where the length extends in a lengthwise direction L₂₂ of the tread element along centerline CL of the tread element and the width W₂₂ extends perpendicular to the lengthwise direction L₂₂ and centerline CL. Length L_{22′} and width W_{22′} connote the overall length and width, respectively, of tread element 22.

It is understood that a projection 30 may be arranged along any wall 20 or edge 26. It is understood that because a wall 20 may extend lengthwise in any direction, an edge 26 may also extend lengthwise in any direction along the ground-engaging side 14 of the tread. Therefore, a projection 30 may extend lengthwise in any direction relative the tread. For example, with reference to FIG. 1, edges 26 are formed along all sides of a tread element 22. For example, edges 26 extending generally in a longitudinal direction of the tread or otherwise forming a lateral side of the tread element 22 may be referred to as side edges 26_{S}, while edges extend generally in a lateral direction of the tread or otherwise forming a front or rear side of the tread element 22 may be referred to as leading or trailing edges, where leading edges 26_{L} are the first edge of the tread element to enter a tire footprint and the trailing edges 26_{T} are the last edge of a tread element to enter a tire footprint. A tire footprint is the area of contact between the tread and a surface upon which a tire is operating. Commonly, side edges extend between leading and trailing edges of a tread element.

With reference to the embodiments shown in FIGS. 1 and 3, tread elements 22 are shown to exemplify the notion that tread elements can be formed such that walls 20 and edges 26 are arranged around the perimeter of the tread element. Likewise, in such instances, projections 30 may also extend around the perimeter tread element as also exemplified in such figures. Of course, one or more projections 30 may be selectively arranged along particular walls 20 or edges 26 such that projections do not extend about the full perimeter of a tread element (that is, extend less than the full perimeter).

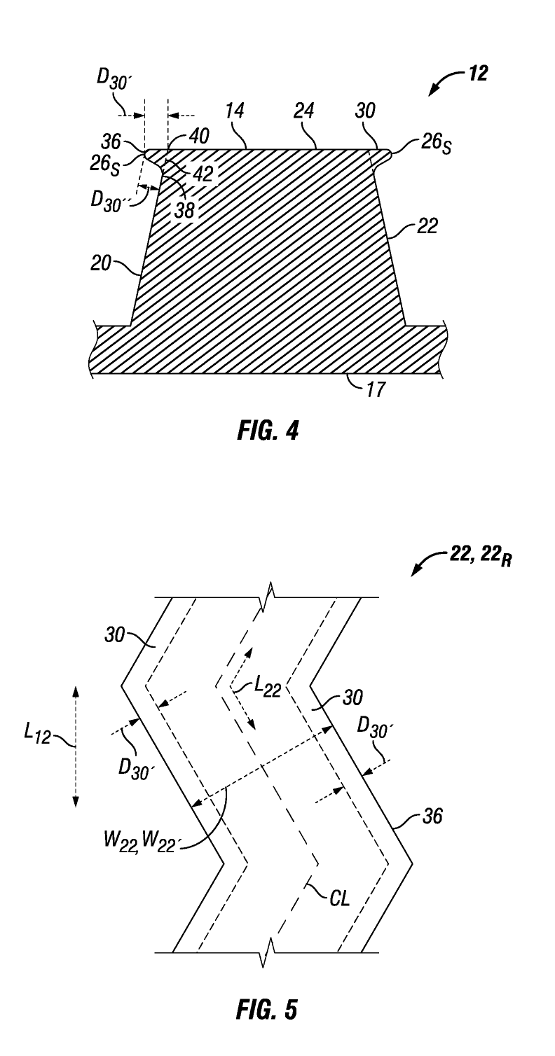

It is also understood that the projection may form any desired shape. For example, with reference to FIGS. 2 and 4, the cross-sectional shape of the projection is shown to be generally triangular, where the projection thickness T₃₀ tapers linearly (see FIG. 2) or non-linearly (see FIG. 4) from a maximum thickness at the wall to a minimum thickness at its terminal end 36. It is also noted that the terminal end and the intersection 38 of the projection 30 and the wall 20 may be sharp, as exemplarily shown in FIG. 2, or rounded, as exemplarily shown in FIG. 4.

With continued reference to the embodiment of FIGS. 2 and 4, each projection 30 includes a top side 32, as noted previously, which generally extends perpendicularly to the depthwise direction of the tread. Each projection 30 also includes a bottom side 34 extending between the wall 20 and the terminal end 36. The top side 32 and the bottom side 34 define the projection thickness T₃₀. In the embodiments shown, the top and bottom sides 32, 34 are angularly oriented or separated by an angle α₃₀. In specific embodiments, angle αₘ is equal to or less than 30 degrees, or equal to or less than 45 degrees. In the embodiment shown, wall 20 extends depthwise at an angle α₂₀ that is greater than zero but less than 90 degrees relative to the depthwise direction of the tread. In other embodiments, it is appreciated that the angle α₂₀ may be equal to zero. In certain instances, for example, angle α₂₀ is equal to 10 degrees or less.

With further reference to the embodiment of FIGS. 2 and 4, each projection protrudes from a corresponding wall by a desired distance. In particular, with reference to a location 40 where the top side 14 of the tread intersects a line 42 representing an extension of the wall identifying the location where the wall would otherwise intersect the top side in the absence of projection 30, the projection extends a distance D_{30′} from intersection location 40. In particular embodiments, distance D_{30′} is equal to approximately 2 millimeters (mm) or less, while in other embodiments D_{30′} is equal to approximately 1 mm or less. Describing the projection another way, it can be said that the protrusion extends a distance D_{30″} from the wall in a direction perpendicular to the wall. In particular embodiments, distance D_{30″} is equal to approximately 2 millimeters (mm) or less, while in other embodiments D_{30″} is equal to approximately 1 mm or less. Generally, D_{30″} equals cosine (α₂₀) multiplied by D_{30′}. In particular embodiments, distance D_{30′} is related to a percentage of the tread element length L_{22′} or width W_{22′} of which the distance D_{30′} partially forms. In such embodiments, distance D_{30′} is equal to or less 20% of DIM, where DIM equals the tread element length L_{22′} or width W_{22′} of which the distance D_{30′} partially forms. For example, if a projection 30 extends a distance D_{30′} in a widthwise direction of the tread element, DIM equals width W_{22′} and D_{30′} equals 20% of W_{22′}. In other embodiments, distance D_{30′} is equal to or less 10% of DIM.

With reference to FIG. 7, a graph is shown comparing the stress concentrations calculated along inventive tread elements against the stress concentrations calculated along a prior art tread element, where the stress concentrations were calculated using finite element analysis. In particular, the graph shows the normal contract stress (identified as Py in the graph along the y-axis) as calculated using finite element analysis for various tread configurations at various widthwise locations taken at particular distances (identified as X in the graph along the x-axis) from a tread centerline (see centerline CL in FIGS. 2 and 4, for example) across the top side of a tread element comprising a rib and up to a side edge of the rib. The normal contact stress is measured in decanewton per square millimeter (daN/mm2), while the location of the measured stress along the width (see W_{22′} in FIGS. 2-4) of the rib is measured in millimeters (mm) It is noted that this location is represented in the graph by a distance, the distance representing the distance from the widthwise center of the tread element width. In all cases tested, the ribs were dimensionally identical except for the presence of projections and the variants of those projections tested. Additionally, for each projection tested, the terminal end of the projection was rounded similarly to the terminal end shown in FIG. 4.

In the graph shown, the normal contact stress was calculated for a reference prior art rib not having any projection extending from a wall along an edge of the rib, which is referred to as plot R in the graph. Additionally, the normal contract stress was calculated for various configurations of the reference rib having projections extending along an edge of the rib were calculated. The different configurations of the rib tested included: (1) a projection having an angle α₃₀ equal to 45 degrees and a distance D_{30′} equal to 1 mm, which is referred to plot P1 in the graph; (2) a projection having an angle α₃₀ equal to 45 degrees and a distance D_{30′} equal to 2 mm, which is referred to plot P2 in the graph; (3) a projection having an angle α₃₀ equal to 30 degrees and a distance D_{30′} equal to 1 mm, which is referred to plot P3 in the graph; and, (4) a projection having an angle α₃₀ equal to 30 degrees and a distance D_{30′} equal to 2 mm, which is referred to plot P4 in the graph. In each of the embodiments tested, the distance D_{30′} is substantially equal to D_{30″} since the angle α₂₀ of the wall 20 was equal to 7.6 degrees. For those projections having a distance D_{30′} equal to 1 mm, because the tread element width W_{22′} equaled approximately 30 mm, distance D_{30′} was approximately equal to 3% of tread element width W_{22′}. For those projections having a distance D_{30′} equal to 2 mm, because the tread element width W_{22′} equaled approximately 30 mm, distance D_{30′} was approximately equal to 6% of tread element width W_{22′}.

Upon review of the results, each rib having a projection distance D_{30′} equal to 1 mm (for each 45 degree and 30 degree configurations P1, P3) provided an approximately 34% reduction in normal contact stress over the prior art rib. Furthermore, the rib having an angle α₃₀ equal to 45 degrees and a distance D_{30′} equal to 2 mm, which is referred to plot P2 in the graph, provided an approximately 43% reduction in normal contact stress over the prior art rib. Finally, the rib having an angle α₃₀ equal to 30 degrees and a distance D_{30′} equal to 2 mm, which is referred to plot P4 in the graph, provided an approximately 53% reduction in normal contact stress over the prior art rib. It is also noted in the graph that the location of the concentration of stress moves outwardly away from the center of the tread element relative the location on the reference tire.

It is also noted that finite element analysis was performed on the same ribs except that the terminal ends were pointed or sharp, and not rounded. As a result, it was found that the rib having an angle α₃₀ equal to 45 degrees and a distance D_{30′} equal to 1 mm provided an approximately 58% reduction in normal contact stress over the prior art rib. The rib having an angle α₃₀ equal to 45 degrees and a distance D_{30′} equal to 2 mm provided an approximately 74 to 90% reduction in normal contact stress over the prior art rib. Furthermore, the ribs having an angle α₃₀ equal to 30 degrees and a distance D_{30′} equal to 1 or 2 mm provided an approximately 90 to 100% reduction in normal contact stress over the prior art rib.

It is noted that, in particular embodiments, the inventive tread discussed herein is attached to a tire, such as is shown exemplary in FIG. 1. Any such tire may comprise a new or original tire, or a retreaded tire. Accordingly, any inventive tread discussed herein may be molded with the original tire according to any known manufacturing process, or may be formed separately and applied to a tire carcass, such as is the case in forming retreaded tires and attached thereto according to any retreading process. In instances where the tread is formed separately, the tread maybe formed in an annular mold to form a ring or in a flat mold to form a length of tread for application to the tire carcass. Moreover, treads may be formed of any known material, including any elastomeric material, such as synthetic or natural rubber. Finally, the inventive treads described herein may be employed by pneumatic tires, such as the tire 10 shown in FIG. 1, or any other tire, such as non-pneumatic tires arranged along an outer perimeter of a wheel, rim or the like. By example, a non-pneumatic tire may comprise a forklift tire.

While this invention has been described with reference to particular embodiments thereof, it shall be understood that such description is by way of illustration and not by way of limitation. Accordingly, the scope and content of the invention are to be defined by the terms of the appended claims.

1. A tire tread comprising:
a length extending longitudinally and a width extending laterally relative the length;
a thickness bounded by a top side for engaging a surface during tire operation and a bottom side for attachment to a tire carcass;
a top side void arranged along the top side of the tread and defining a wall extending depthwise within the tread thickness from the top side; and, a projection extending outwardly from a top of the wall along and to a terminal end of the projection, the projection having a top side forming a portion of the top side of the tread and a bottom side defining a thickness of the projection, the projection also having a length extending substantially along a full length of the wall, the length of the wall extending perpendicular to a depthwise direction of the tread thickness.

2. The tire tread of claim 1, where the projection thickness narrows as the projection extends from the wall to the terminal end.

3. The tire tread of claim 2, where the terminal end forms a tip.

4. The tire tread of claim 2, where the top side and a bottom side are angularly separated by an angle equal to or greater than approximately 30 degrees to define the projection thickness.

5. The tire tread of claim 1, where the projection extends from the wall by a distance of at least 1 mm.

6. The tire tread of claim 1, where the projection extends from the wall by a distance of at least 2 mm.

7. The tire tread of claim 1, where the projection forms an extension of the top side and the wall such that the terminal end forms an edge arranged along the top side of the tread.

8. The tire tread of claim 7, where the top side of the projection forms an extension of the top side of the tread.

9. The tire tread of claim 7, where the top side of the projection is aligned with the top side of the tread relative a depthwise direction of the tread.

10. The tire tread of claim 1, where the tread further includes a tread element arranged adjacent the top side void, the tread element including one or more walls extending depthwise within the tread thickness, the wall of the top side void forming one of the one or more walls of the tread element, the tread element further including a terminal end forming a portion of the top side of the tread and being defined by one or more edges forming an intersection of the top side and the wall, where the projection is arranged along the wall such that the projection forms one of the one or more edges.

11. The tire tread of claim 10, where the terminal end of the projection forms one of the one or more edges.

12. (canceled)

13. The tire tread of claim 1, where the projection is continuous along its length.

14. The tire tread of claim 10, where the projection forms a side edge of the tread element, the tread element forming a block or rib of the tread.

15. The tire tread of claim 10, where the projection forms a leading or trailing edge of the tread element, the tread element forming a block or rib of the tread.

16. The tire tread of claim 1, where the tread is attached to a tire carcass to form a tire.

17. A tire comprising:
a tire carcass;
a tread comprising:
a length extending longitudinally and a width extending laterally relative the length;
a thickness bounded by a top side for engaging a surface during tire operation and a bottom side for attachment to a tire carcass;
a top side void arranged along the top side of the tread and defining a wall extending depthwise within the tread thickness from the top side; and, a projection extending outwardly from a top of the wall along and to a terminal end of the projection, the projection having a top side forming a portion of the top side of the tread and a bottom side defining a thickness of the projection, the projection also having a length extending substantially along a full length of the wall, the length of the wall extending perpendicular to a depthwise direction of the tread thickness.

18. The tire of claim 17, where the projection forms an extension of the top side and the wall such that the terminal end forms an edge arranged along the top side of the tread.

19. The tire of claim 17, where the projection thickness narrows as the projection extends from the wall to the terminal end.

20. The tire of claim 17, where the tread further includes a tread element arranged adjacent the top side void, the tread element including one or more walls extending depthwise within the tread thickness, the wall of the top side void forming one of the one or more walls of the tread element, the tread element further including a terminal end forming a portion of the top side of the tread and being defined by one or more edges forming an intersection of the top side and the wall, where the projection is arranged along the wall such that the projection forms one of the one or more edges.

21. The tire tread of claim 1, where the projection is spaced above the bottom side.
